(19) United States
(12) Patent Application Publication
(10) Pub. No.: US 2008/0193772 A1
(43) Pub. Date: Aug. 14, 2008

(54) MASS SPECTROMETRY PROBES HAVING HYDROPHOBIC COATIINGS

(75) Inventors: Yury Agroskin, Cupertino, CA (US); Michael T. Grimes, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Bio-Rad Laboratories, Inc, Hercules, CA (US)

(21) Appl. No.: 11/773,839

(22) Filed: Jul. 5, 2007

Related U.S. Application Data
(60) Provisional application No. 60/819,148, filed on Jul. 7, 2006.

(51) Int. Cl. B32B 27/00; B05D 3/06

(52) U.S. Cl. 428/421; 427/558

(57) ABSTRACT

This invention provides a mass spectrometry probe including a substrate having a surface and a hydrophobic coating that coats the surface. The hydrophobic coating includes openings that define features for the presentation of an analyte. The hydrophobic coating also has a lower surface tension that the features on the substrate surface, and has a water contact angle between 115° and 140°.

### CROSS-REFERENCES TO RELATED APPLICATIONS

This application is related to U.S. Provisional Application No. 60/819,148, filed Jul. 7, 2006, the disclosure of which is hereby incorporated by reference in its entirety for all purposes.

### STATEMENT AS TO RIGHTS TO INVENTIONS MADE UNDER FEDERALLY SPONSORED RESEARCH OR DEVELOPMENT

Not Applicable

### REFERENCE TO A “SEQUENCE LISTING,” A TABLE, OR A COMPUTER PROGRAM LISTING APPENDIX SUBMITTED ON A COMPACT DISK

Not Applicable

### BACKGROUND OF THE INVENTION

Modern laser desorption/ionization mass spectrometry (“LDI-MS”) can be practiced in two main variations: matrix assisted laser desorption/ionization (“MALDI”) mass spectrometry and surface-enhanced laser desorption/ionization (“SELDI”). In MALDI, the analyte, which may contain biological molecules, is mixed with a solution containing a matrix, and a drop of the liquid is placed on the surface of a probe. The matrix solution then co-crystallizes with the biological molecules. The probe is inserted into the mass spectrometer. Laser energy is directed to the probe surface where it desorbs and ionizes the biological molecules without significantly fragmenting them. However, MALDI has limitations as an analytical tool. It does not provide means for fractionating the sample, and the matrix material can interfere with detection, especially for low molecular weight analytes. See, e.g., U.S. Pat. No. 5,118,937 (Hillenkamp et al.), and U.S. Pat. No. 5,045,694 (Beavis & Chait).

In SELDI, the probe surface is modified so that it is an active participant in the analyte recovery and/or desorption process. In one variant, the surface is derivatized with affinity reagents that selectively bind the analyte. In another variant, the surface is derivatized with energy absorbing molecules that are not desorbed when struck with the laser. In another variant, the surface is derivatized with molecules that bind the analyte and that contain a photolytic bond that is broken upon application of the laser. In each of these methods, the derivatizing agent generally is localized to a specific location on the probe surface where the sample is applied. See, e.g., U.S. Pat. Nos. 5,719,060 and 6,225,047, all of which issued to Hutchens and Yip, and PCT International Publication No. WO 98/59361, also to Hutchens and Yip.

The two methods can be combined by, for example, using a SELDI affinity surface to capture an analyte and adding matrix-containing liquid to the captured analyte to provide the energy absorbing material.

In the practice of mass spectrometry, localizing the sample on the probe surface provides advantages. Localization provides more concentrated sample at the point of laser application. In the affinity version of SELDI, localization can be important because it allows the affinity reagent to capture more of the analyte, thereby providing greater sensitivity of detection. However, if the hydrophilic or hydrophobic characteristics of the liquid are similar to that of the probe, liquid samples tend to spread out over the surface of the probe, thwarting localization. This especially creates problems when the probe is designed to hold multiple samples and the samples cannot be sequestered to specific locations.

U.S. Pat. No. 6,555,813 (Beecher et al.) discloses a mass spectrometry probe comprising a substrate having a surface and a hydrophobic film that coats the surface of the substrate. The film includes openings that define features for the presentation of an analyte. The film is more hydrophobic than the surface (lower surface tension), thereby localizing the sample to the defined features.

Even though much has been achieved with mass spectrometry probes disclosed in U.S. Pat. No. 6,555,813, which have hydrophobic coatings, there is still a need for additional means for sequestering a liquid sample to a location on a probe surface.

### BRIEF SUMMARY OF THE INVENTION

This invention provides a mass spectrometry probe capable of sequestering liquid samples to specific locations, i.e., openings or features, of the probe surface. The probes comprise a substrate having a surface, a first coating of silicon dioxide or titanium dioxide on the probe surface, a second coating of a fluoroalkylsilane chemically coupled to the first coating, wherein the second coating comprises a plurality of openings at which the polyfloroalkylsilane is not coupled or present, and an adsorbent material physisorbed or chemisorbed to the first coating at the plurality of openings. The second coating is advantageous more hydrophobic than the openings or features of the probe (lower surface tension) and, thus, the samples used in mass spectrometry, which are typically dissolved in aqueous solutions, are selectively sequestered to the openings or features of the probe.

The fluoroalkylsilane coatings of the present invention provide several advantages compared with mechanical borders. First, they avoid electrical field perturbations that hamper mass resolving power and mass accuracy. Second, they avoid areas of possible sample pooling and preferential crystallization in regions other than the probed area. Third, they avoid the need for maintaining strict mechanical tolerances such as in the case of elevated sample ridges or depressed sample wells, which can result in poor molecular weight determination accuracy and precision. Fourth, they avoid, unlike elevated margins, an optical stop which limits the probed area. Moreover, since an adsorbent material is physisorbed or chemisorbed to the first coating at the plurality of openings in a stable and robust way, the probes of the present invention can be advantageously used to capture analytes by providing adsorbent materials that are derivatized in any number of ways to allow non-covalent affinity interaction (adsorption) between the adsorbent material and the analyte of interest.

As such, in one aspect, the present invention provides a probe comprising: (a) a solid substrate; (b) a first coating of silicon dioxide or titanium dioxide on a surface of the substrate; (c) a second coating of a polyfluoroalkylsilane chemically coupled to the first coating, wherein the second coating comprises a plurality of openings at which the polyfluoroalkylsilane is not coupled; and (d) an adsorbent material physisorbed and/or chemisorbed to the first coating at the plurality of openings.

In one embodiment, the probe takes the shape of a flat strip or plate. In another embodiment, the probe further comprises means for engaging a probe interface of a laser desorption mass spectrometer. In certain embodiments, the solid substrate comprises a conductive material. Examples of suitable conductive materials include, but are not limited to, aluminum, iron or gold. In other embodiments, the solid substrate comprises a conductive polymer or a polymer doped with a material that renders it conductive. In other embodiments, the solid substrate comprises a non-conductive material. Examples of suitable non-conductive materials include, but are not limited to, glass, plastic and ceramic oxide.

The second coating preferably comprises a fluoroalkylsilane. In certain embodiments, the fluoroalkylsilane comprises (heptadecafluoro-1,1,2,2-tetra-hydrodecyl)trichlorosilane (FDTS) or (tridecafluoro-1,1,2,2-tetrahydrooctyl)trichlorosilane (FOTS). In a preferred embodiment, the fluoroalkylsilane comprises FDTS.

The adsorbent material can be any material capable of binding an analyte. The adsorbent material is attached to the first coating by physisorption or chemisorption. In certain embodiments, the adsorbent material is coupled to the surface through polymerization with a vinyl group of an acrylate or a methacrylate group of an alkylsilane coupled to the first coating. Examples of suitable adsorbent materials include, but are not limited to, a hydrophilic material, a hydrophobic material, an anion exchange material, a cation exchange material, a metal chelating material, a dye, an epoxide, a carboimidizole, an affinity ligand or a biospecific material. In certain embodiments, the adsorbent material comprises a polymeric hydrogel. Suitable hydrogels comprise acrylate, methacrylate, polyurethane or polysaccharide polymers.

In certain embodiments, the plurality of openings take the form of spots arranged in a line or a grid having the same dimensions as a line or grid of spots in a 96-well or 384-well plate.

In another aspect, the present invention provides a method of making a probe, the method comprising: (a) coating a surface of a solid substrate with a first coating of silicon dioxide or titanium dioxide (by molecular vapor deposition); (b) coating the first coating with a second coating of a polyfluoroalkylsilane; (c) covering the second coating with a mask comprising a plurality of openings that expose a plurality of areas on the second coating; (d) exposing the probe to UV ozone to remove the polyfluoroalkylsilane from the exposed areas; and (e) attaching by physisorption or chemisorption an adsorbent material at each of the exposed areas.

In yet another aspect, the present invention provides a probe of this invention that is removably insertable into a gas phase ion detector (e.g., a mass spectrometer).

In another aspect, the present invention provides a system comprising: a gas phase ion detector comprising an inlet port; and a probe of this invention inserted into the inlet port.

In a further aspect, the present invention provides a method of detecting an analyte, the method comprising: a) placing the analyte on a feature of a surface of a probe of this invention; b) inserting the probe into an inlet port of a gas phase ion detector comprising: i) an ionization source that desorbs the analyte from the probe surface into a gas phase and ionizes the analyte; and ii) an ion detector in communication with the probe surface that detects desorbed ions; c) desorbing and ionizing the analyte with the ionization source; and d) detecting the ionized analyte with the ion detector.

### BRIEF DESCRIPTION OF THE DRAWINGS

FIG. 1 shows a sample mass spectrometry probe with of this invention, wherein 101 is the substrate, 102 is the lip of the substrate 101, 103 is the spot or feature, 104 is the roughened surface, 105 is the glass layer or coating, 106 is the fluoroalkylsilane (e.g., FTDS) layer, 107 is the silane anchor; and 108 is the adsorbent.

FIG. 2 illustrates a flow-diagram of a method used to generate the probes of the present invention in accordance with the embodiment illustrated in FIG. 1.

### DETAILED DESCRIPTION OF THE INVENTION

### I. Definitions

Unless defined otherwise, all technical and scientific terms used herein have the meaning commonly understood by a person skilled in the art to which this invention belongs. The following references provide one of skill with a general definition of many of the terms used in this invention: Singleton et al., Dictionary of Microbiology and Molecular Biology (2^{nd} ed. 1994); The Cambridge Dictionary of science and Technology (Walker ed., 1988); The Glossary of Genetics, 5^{th} Ed., R. Rieger et al. (eds.), Springer Verlag (1991); and Hale & Marham, The Harper Collins Dictionary of Biology (1991). As used herein, the following terms have the meanings ascribed to them unless specified otherwise.

“Attached,” as used herein, encompasses interactions including chemisorption and physisorption.

“Biomolecule” or “bioorganic molecule” refers to an organic molecule typically made by living organisms. This includes, for example, molecules comprising nucleotides, amino acids, sugars, fatty acids, steroids, nucleic acids, polypeptides, peptides, peptide fragments, carbohydrates, lipids, and combinations of these (e.g., glycoproteins, ribonucleoproteins, lipoproteins, or the like). Biomolecules can be sourced from any biological material.

“Coupled,” as used herein, encompasses chemisorption interactions, wherein one entity is chemically bound to another entity.

“Probe,” as used herein, refers to a device that comprises a substrate having a surface adapted for the presentation of an analyte for detection and that includes means for engaging a probe interface of a mass spectrometer, which positions the probe so that the probe surface can be interrogated by an energy source. Thus, the probe is removably insertable into a gas phase ion detector (e.g., a mass spectrometer).

“Substrate” refers to a solid material that is capable of supporting an analyte.

“Surface” refers to the exterior or upper boundary of a body or a substrate.

“Coating” refers to a thin film or layer of silicon dioxide or titanium dioxide or of a fluoroalkylsilane coating on the surface of a substrate.

“Surface tension,” as used herein, refers to the reversible work required to create a unit surface area at constant temperature and pressure and composition. Surface tension is measured by: g=(dG/dA)T,P,n where g=the surface tension; G=Gibbs free energy of the system; A=surface area; T=temperature; P=pressure; and N=composition.

“Contact angle,” as used herein, refers to the angle between the plane of the solid surface and the tangential line to the liquid boundary originating at the point of three phase contact (solid/liquid/vapor).

“Strip” refers to a long narrow piece of a material that is substantially flat or planar.

“Plate” refers to a thin piece of material that is substantially flat or planar, and that can be in any suitable shape (e.g., rectangular, square, oblong, circular, etc.).

“Substantially flat” refers to a substrate having the major surfaces essentially parallel and distinctly greater than the minor surfaces (e.g., a strip or a plate).

“Gas phase ion spectrometer” refers to an apparatus that detects gas phase ions. Gas phase ion spectrometers include an ion source that supplies gas phase ions. Gas phase ion spectrometers include, for example, mass spectrometers, ion mobility spectrometers, and total ion current measuring devices. “Gas phase ion spectrometry” refers to the use of a gas phase ion spectrometer to detect gas phase ions.

“Mass spectrometer” refers to a gas phase ion spectrometer that measures a parameter that can be translated into mass-to-charge ratios of gas phase ions. Mass spectrometers generally include an ion source and a mass analyzer. Examples of mass spectrometers are time-of-flight, magnetic sector, quadrupole filter, ion trap, ion cyclotron resonance, electrostatic sector analyzer and hybrids of these. “Mass spectrometry” refers to the use of a mass spectrometer to detect gas phase ions.

“Laser desorption mass spectrometer” refers to a mass spectrometer that uses laser energy as a means to desorb, volatilize, and ionize an analyte. Laser desorption/ionization in a single TOF instrument typically is performed in linear extraction mode. Tandem mass spectrometers can employ orthogonal extraction modes.

“Mass analyzer” refers to a sub-assembly of a mass spectrometer that comprises means for measuring a parameter that can be translated into mass-to-charge ratios of gas phase ions. In a time-of-flight mass spectrometer the mass analyzer comprises an ion optic assembly that accelerates ions into the flight tube, a flight tube and an ion detector.

“Ion source” refers to a sub-assembly of a gas phase ion spectrometer that provides gas phase ions. In one embodiment, the ion source provides ions through a desorption/ionization process. Such embodiments generally comprise a probe interface that positionally engages a probe in an interrogatable relationship to a source of ionizing energy (e.g., a laser desorption/ionization source) and in concurrent communication at atmospheric or subatmospheric pressure with a detector of a gas phase ion spectrometer.

Forms of ionizing energy for desorbing/ionizing an analyte from a solid phase include, for example: (1) laser energy; (2) fast atoms (used in fast atom bombardment); (3) high energy particles generated via beta decay of radionucleides (used in plasma desorption); and (4) primary ions generating secondary ions (used in secondary ion mass spectrometry). The preferred form of ionizing energy for solid phase analytes is a laser (used in laser desorption/ionization), in particular, nitrogen lasers, Nd-Yag lasers and other pulsed laser sources. “Fluence” refers to the energy delivered per unit area of interrogated image. A high fluence source, such as a laser, will deliver about 1 mJ/mm² to about 50 mJ/mm². Typically, a sample is placed on the surface of a probe, the probe is engaged with the probe interface and the probe surface is exposed to the ionizing energy. The energy desorbs analyte molecules from the surface into the gas phase and ionizes them.

Other forms of ionizing energy for analytes include, for example: (1) electrons that ionize gas phase neutrals; (2) strong electric field to induce ionization from gas phase, solid phase, or liquid phase neutrals; and (3) a source that applies a combination of ionization particles or electric fields with neutral chemicals to induce chemical ionization of solid phase, gas phase, and liquid phase neutrals.

This invention is directed to probes useful for a mass spectrometric technique known as “Surface Enhanced Laser Desorption and Ionization” or “SELDI,” as described, for example, in U.S. Pat. Nos. 5,719,060 and 6,225,047, both to Hutchens et al. This refers to a method of desorption/ionization gas phase ion spectrometry (e.g., mass spectrometry) in which an analyte (here, one or more of the analytes) is captured on the surface of a SELDI mass spectrometry probe.

SELDI also has been called “affinity capture mass spectrometry” or “Surface-Enhanced Affinity Capture” (“SEAC”). This version involves the use of probes that have a material on the probe surface that captures analytes through a non-covalent affinity interaction (adsorption) between the material and the analyte. The material is variously called an “adsorbent,” a “capture reagent,” an “affinity reagent” a “binding functionality or a “binding moiety.” Such probes can be referred to as “affinity capture probes” and as having an “adsorbent surface.” The capture reagent can be any material capable of binding an analyte. The capture reagent is attached to the probe surface by physisorption or chemisorption. In certain embodiments the probes have the capture reagent already attached to the surface. In other embodiments, the probes are pre-activated and include a reactive moiety that is capable of binding the capture reagent, e.g., through a reaction forming a covalent or coordinate covalent bond. Epoxide and acyl-imidizole are useful reactive moieties to covalently bind polypeptide capture reagents such as antibodies or cellular receptors. Nitrilotriacetic acid and iminodiacetic acid are useful reactive moieties that function as chelating agents to bind metal ions that interact non-covalently with histidine containing peptides. Adsorbents are generally classified as chromatographic adsorbents and biospecific adsorbents.

“Binding functionalities,” as used herein, refer to a functional group(s) that binds an analyte of interest. Binding functionalities include, but are not limited to, a carboxyl group, a sulfonate group, a phosphate group, an ammonium group, a hydrophilic group, a hydrophobic group, a reactive group, a metal chelating group, a thioether group, a biotin group, a boronate group, a dye group, a cholesterol group, derivatives thereof, or any combinations thereof. Binding functionalities can further include other functionalities that can bind analytes based on individual structural properties, such as the interaction of antibodies with antigens, enzymes with substrate analogs, nucleic acids with binding proteins, and hormones with receptors.

“Chromatographic adsorbent” refers to an adsorbent material typically used in chromatography. Chromatographic adsorbents include, for example, ion exchange materials, metal chelators (e.g., nitrilotriacetic acid or iminodiacetic acid), immobilized metal chelates, hydrophobic interaction adsorbents, hydrophilic interaction adsorbents, dyes, simple biomolecules (e.g., nucleotides, amino acids, simple sugars and fatty acids) and mixed mode adsorbents (e.g., hydrophobic attraction/electrostatic repulsion adsorbents).

“Biospecific adsorbent” refers to an adsorbent comprising a biomolecule, e.g., a nucleic acid molecule (e.g., an aptamer), a polypeptide, a polysaccharide, a lipid, a steroid or a conjugate of these (e.g., a glycoprotein, a lipoprotein, a glycolipid, a nucleic acid (e.g., DNA)-protein conjugate). In certain instances, the biospecific adsorbent can be a macromolecular structure such as a multiprotein complex, a biological membrane or a virus. Examples of biospecific adsorbents are antibodies, receptor proteins and nucleic acids. Biospecific adsorbents typically have higher specificity for a target analyte than chromatographic adsorbents. Further examples of adsorbents for use in SELDI can be found in U.S. Pat. No. 6,225,047. A “bioselective adsorbent” refers to an adsorbent that binds to an analyte with an affinity of at least 10⁻⁸ M.

Various chemistries for adsorbents are further described in: U.S. Pat. No. 6,579,719 (Hutchens et al., “Retentate Chromatography,” Jun. 17, 2003); U.S. Pat. 6,897,072 (Rich et al., “Probes for a Gas Phase Ion Spectrometer,” May 24, 2005); U.S. Patent Publication No. U.S. 2003 0032043 A1 (Pohl et al., “Latex Based Adsorbent Chip,” Jul. 16, 2002); PCT International Publication No. WO 03/040700 (Um et al., “Hydrophobic Surface Chip,” May 15, 2003); U.S. Patent Publication No. US 2003/0218130 A1 (Boschetti et al., “Biochips With Surfaces Coated With Polysaccharide-Based Hydrogels,” Apr. 14, 2003); and U.S. Pat. No. 7,045,366, (Huang et al., “Photocrosslinked Hydrogel Surface Coatings,” May 16, 2006).

In general, a probe with an adsorbent surface is contacted with the sample for a period of time sufficient to allow the analyte or analytes that may be present in the sample to bind to the adsorbent. After an incubation period, the substrate is washed to remove unbound material. Any suitable washing solutions can be used; preferably, aqueous solutions are employed. The extent to which molecules remain bound can be manipulated by adjusting the stringency of the wash. The elution characteristics of a wash solution can depend, for example, on pH, ionic strength, hydrophobicity, degree of chaotropism, detergent strength, and temperature. Unless the probe has both SEAC and SEND properties (as described herein), an energy absorbing molecule then is applied to the substrate with the bound analytes.

In yet another method, one can capture the analytes with a solid-phase bound immuno-adsorbent that has antibodies that bind the analytes. After washing the adsorbent to remove unbound material, the analytes are eluted from the solid phase, applied to a SELDI biochip that binds the analytes and analyzed by SELDI.

The analytes bound to the substrates are detected in a gas phase ion spectrometer such as a time-of-flight mass spectrometer. The analytes are ionized by an ionization source such as a laser, the generated ions are collected by an ion optic assembly, and then a mass analyzer disperses and analyzes the passing ions. The detector then translates information of the detected ions into mass-to-charge ratios. Detection of a analyte typically will involve detection of signal intensity. Thus, both the quantity and mass of the analyte can be determined.

Another method of laser desorption mass spectrometry is called Surface-Enhanced Neat Desorption (“SEND”). SEND involves the use of probes comprising energy absorbing molecules that are chemically bound to the probe surface (“SEND probe”). The phrase “energy absorbing molecules” (EAM) denotes molecules that are capable of absorbing energy from a laser desorption/ionization source and, thereafter, contribute to desorption and ionization of analyte molecules in contact therewith. The EAM category includes molecules used in MALDI, frequently referred to as “matrix,” and is exemplified by cinnamic acid derivatives, sinapinic acid (SPA), cyano-hydroxy-cinnamic acid (CHCA) and dihydroxybenzoic acid, ferulic acid, and hydroxyaceto-phenone derivatives. In certain embodiments, the energy absorbing molecule is incorporated into a linear or cross-linked polymer, e.g., a polymethacrylate. For example, the composition can be a co-polymer of α-cyano-4-methacryloyloxycinnamic acid and acrylate. In another embodiment, the composition is a co-polymer of α-cyano-4-methacryloyloxycinnamic acid, acrylate and 3-(tri-ethoxy)silyl propyl methacrylate. In another embodiment, the composition is a co-polymer of α-cyano-4-methacryloyloxycinnamic acid and octadecylmethacrylate (“C18 SEND”). SEND is further described in U.S. Pat. No. 6,124,137 and PCT International Publication No. WO 03/64594 (Kitagawa, “Monomers And Polymers Having Energy Absorbing Moieties of Use In Desorption/Ionization Of Analytes,” Aug. 7, 2003).

SEAC/SEND is a version of SELDI in which both a capture reagent and an energy absorbing molecule are attached to the sample presenting surface. SEAC/SEND probes therefore allow the capture of analytes through affinity capture and ionization/desorption without the need to apply external matrix. The C18 SEND biochip is a version of SEAC/SEND, comprising a C18 moiety which functions as a capture reagent, and a CHCA moiety which functions as an energy absorbing moiety.

Another version of LDI is called Surface-Enhanced Photolabile Attachment and Release (“SEPAR”). SEPAR involves the use of probes having moieties attached to the surface that can covalently bind an analyte, and then release the analyte through breaking a photolabile bond in the moiety after exposure to light, e.g., to laser light (see, U.S. Pat. No. 5,719,060). SEPAR and other forms of SELDI are readily adapted to detecting a analyte or analyte profile, pursuant to the present invention.

“Analyte” refers to any component of a sample that to be detected and/or separated from a contaminant. The term can refer to a single component or a plurality of components in the sample. Analytes include, for example, biomolecules.

“Eluant” or “wash solution” refers to an agent, typically a solution, which is used to affect or modify adsorption of an analyte to an adsorbent surface and/or remove unbound materials from the surface. The elution characteristics of an eluant can depend, for example, on pH, ionic strength, hydrophobicity, degree of chaotropism, detergent strength and temperature.

As used herein, “contaminant,” refers to species removed from a sample or assay mixture. The contaminant can be an extraneous species not of interest in the assay, or it can be material of interest that is present in excess of the amount needed to perform the assay. When the excess “contaminating” analyte negatively affects the dynamic range of detection in the assay, its removal provides a method of enhancing properties of the assay including, but not limited to, its sensitivity.

The terms, “assay mixture” and “sample,” are used interchangeable to refer to a mixture that includes the analyte and other components. The other components are, for example, diluents, buffers, detergents, and contaminating species, debris and the like that are found mixed with the target. Illustrative examples include urine, sera, blood plasma, total blood, saliva, tear fluid, cerebrospinal fluid, secretory fluids from nipples and the like. Also included are solid, gel or sol substances such as mucus, body tissues, cells and the like suspended or dissolved in liquid materials such as buffers, extractants, solvents and the like.

“Adsorb” refers to the detectable binding between binding functionalities and an analyte either before or after washing with an eluant (selectivity threshold modifier).

“Resolve,” “resolution,” or “resolution of analyte” refers to the detection of at least one analyte in a sample. Resolution includes the detection of a plurality of analytes in a sample by separation and subsequent differential detection. Resolution does not require the complete separation of an analyte from all other analytes in a mixture. Rather, any separation that allows the distinction between at least two analytes suffices.

“Detect” refers to identifying the presence, absence or amount of the object to be detected.

“Energy absorbing molecule” or “EAM” refers to a molecule that absorbs energy from an energy source in a mass spectrometer thereby enabling desorption of analyte from a probe surface. Energy absorbing molecules used in MALDI are frequently referred to as “matrix.” Cinnamic acid derivatives, sinapinic acid and dihydroxybenzoic acid are frequently used as energy absorbing molecules in laser desorption of bioorganic molecules. See U.S. Pat. 5,719,060 (Hutchens & Yip) for additional description of energy absorbing molecules.

### II. Probes

This invention provides probes that are removably insertable into a mass spectrometer. The probes comprise a substrate having a surface, a first coating of silicon dioxide or titanium dioxide on the probe surface, a second coating of a polyfluoroalkylsilane chemically coupled to the first coating, wherein the second coating comprises a plurality of openings at which the polyfloroalkylsilane is not present, and an adsorbent material physisorbed or chemisorbed to the first coating at the plurality of openings. The second coating has a greater water contact angle and lower surface energy than the plurality of openings (i.e., the plurality of feature or spots) so that liquid applied to the exposed areas tend to be sequestered in the plurality of openings. In certain embodiments, the coatings of this invention are significantly more hydrophobic than coatings that can be applied manually.
A. Substrate

The substrate can be made from any solid material that is capable of supporting the first and second coatings, the adsorbent material and the sample. For example, the substrate material can include, but is not limited to, glass, ceramic (e.g., titanium oxide, silicon oxide), organic polymers, metals (e.g., nickel, brass, steel, aluminum, gold), paper, a composite of metal and polymers, or combinations thereof. In a preferred embodiment, the solid substrate comprises a conductive material (e.g., aluminum, iron or gold) or, alternatively, comprises a polymer doped with a paramagnetic material.

The substrate can have various properties. The substrates generally are non-porous and substantially rigid to provide structural stability. In certain embodiments, the surface of the substrate is smooth, whereas in other embodiments, the substrate can be conditioned by roughening or other chemical means. For example, a metal substrate can be roughened via laser etching and then coated with a silicon dioxide or titanium oxide coating.

The substrate is electrically conducting to reduce surface charge and to improve mass resolution. Electrical conductivity can be achieved by using materials, such as metals (aluminum, stainless steel, gold) or electrically conductive polymers (e.g., carbonized polyetheretherketone, polyacetylenes, polyphenylenes, polypyrroles, polyanilines, polythiophenes, etc.), or conductive particulate fillers (e.g., carbon black, metallic powders, conductive polymer particulates, fiberglass-filled plastics/polymers, elastomers, etc.).

The substrate can be in any shape as long as it allows the probe to be removably insertable into a mass spectrometer. Many companies make laser desorption mass spectrometers, including, for example, ABI/MDS, Bruker Daltonics, Ciphergen, Shimadzu/Kratos and Micromass. The probe interfaces of each of these mass spectrometers accept probes having the proper dimensions and engagement means. It is understood that to be a probe that is removably insertable into a mass spectrometer, a device must include the proper dimensions and engagement means to engage the probe interface of a mass spectrometer.

In one embodiment, the substrate is substantially flat and substantially rigid. Typically, a probe can take the shape of a rod, wherein a surface at one end of the rod is the sample presenting surface, a strip or a rectangular or circular plate. Furthermore, the substrate can have a thickness of between about 0.1 mm to about 10 cm or more, preferably between about 0.5 mm to about 1 cm or more, most preferably between about 0.8 mm and about 0.5 cm or more. Preferably, the substrate itself is large enough so that it is capable of being manipulated by hand. For example, the longest cross dimension of the substrate can be at least about 1 cm or more, preferably about 2 cm or more, most preferably at least about 5 cm or more.

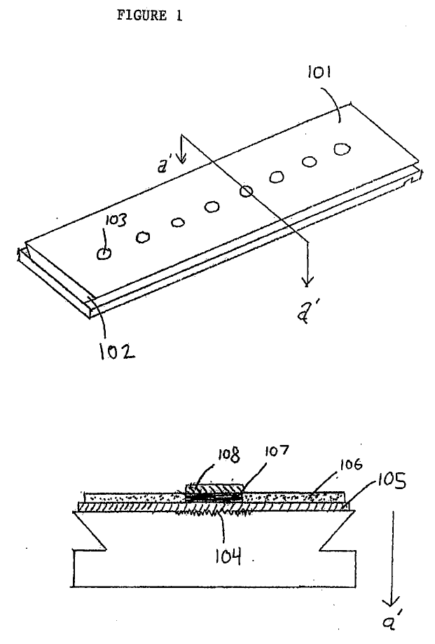

An exemplary structure according to this description is a probe that includes means for slidably engaging a groove in an interface, such as that used in the Ciphergen probes (FIG. 1). In this figure, the means to position the probe in the sample chamber is integral to substrate 101, which includes a lip 102 that engages a complementary receiving structure in the probe.

In another example, the probe is round and is typically attached to a holder/actuator using a magnetic coupler. The target is then pushed into a repeller and makes intimate contact to insure positional and electrical certainty.

Other probes are rectangular and they either marry directly to a carrier using a magnetic coupling or physically attach to a secondary carrier using pins or latches. The secondary carrier then magnetically couples to a sample actuator. This approach is generally used by systems which have autoloader capability and the actuator is generally a classical x, y 2-D stage.

In yet another exemplary embodiment, the probe is a barrel. The barrel supports a polymer, hydrogel or other species that binds to an analyte. By rotating and moving in the vertical plane, a 2-D stage is created.

Still a further exemplary embodiment the probe is a disk. The disk is rotated and moved in either a vertical or horizontal position to create an r-theta stage. Such disks are typically engaged using either magnetic or compression couplers.

In one aspect, the invention provides a device in chip format removable inserted into the probe region of a mass spectrometer.

In a preferred embodiment, the probes of this invention are adapted for SELDI. Accordingly, as explained below, the areas of the surfaces that will form the features can have adsorbents attached that will selectively bind analytes. The adsorbents can he highly specific for an analyte, such as antibodies, or they can be relatively unspecific, such as anion or cation exchange resins. Alternatively, the surface can have energy absorbing molecules or photolabile attachment groups attached. For examples of each, see U.S. Pat. No. 5,719,060 (Hutchens & Yip) and PCT International Publication No. WO 98/59361 (Hutchens & Yip).
B. Coatings

The substrate of the probe of this invention is coated with a first coating to which a silane can be attached, e.g., silicon dioxide or titanium dioxide. The first coating is typically applied using chemical or vapor deposition. Thereafter, a second coating of a hydrophobic material, such as a fluoroalkylsilane (FAS), is chemically coupled to the first coating. The second coating is modified to comprise a plurality of openings at which the polyfluoroalkylsilane is removed, thereby exposing the first coating. The purpose of the second coating is two-fold. First, the second coating defines the locations where the subsequent adsorption layer and sample is to be placed, also called features or openings. Second, because it has a higher water contact angle and less surface tension than the plurality of openings (spots or features) on the probe surface, the second coating provides a barrier against the overflow of liquid sample placed on the features.

In order for the second coating to sequester the liquid sample, it should have less surface tension and a higher contact angle than the spot or feature of the probe. Generally, the sample will be an aqueous solution. In this case, to perform its function, the second coating will be hydrophobic. However, this invention contemplates other liquid samples, as well. In this case, the second coating will be made of a material that does not dissolve in the liquid of the sample. Best results also are obtained when the second coating has a water contact angle of at least about 20° higher, and more preferably at least about 30° higher or at least about 40° higher, than the contact angle of the spot or feature. Most preferably, the water contact angle of the second coating is about 115° to about 140°, whereas the contact angle of the spot or feature can be about 90° or lower.

The film has a thickness on the probe surface of between 1 angstrom and 1 mm. Preferably, the thickness is between 1 micron and 1000 microns (1 mm.) Most preferably, the film has a thickness of between about 10 microns and 500 microns. A thickness of around 100 microns is particularly useful.

The second coating coats the surface of the probe in such a way as to leave a plurality of openings or lacunas in the coating that exposes the surface of the probe. The plurality of openings defines a feature where the adsorbent and then sample will be applied. In one embodiment, the film will form a continuous coating over a substantial surface of the probe with a plurality of openings placed throughout the continuous surface. The features preferably are arranged in an orderly fashion, such as a linear, rectangular or circular array for easy addressability.

In another embodiment, while the film need not coat the entire surface of the probe, it should encircle the opening with sufficient width as to carry out the function of providing a barrier to the spilling over of liquid. Generally, the band of film that encircles the lacuna will be at least 0.3 mm wide and more preferably, at least 1.5 mm wide.

When the probe is adapted for SELDI, the second coating will generally surround the features that have the adsorbent materials attached. Thus, the film acts as a hydrophobic sea surrounding an island of adsorbent materials.

The second coating preferably comprises a di- or tri-functional fluorinated compound. The functional groups of the fluorinated compound are selected such that they are able to react with the silicon dioxide or the titanium dioxide as well as with itself. In a preferred embodiment, one functionality is, for example, methoxy- ethoxy- or chlorosilane, and the other functionality is also methoxy- ethoxy-, chlorosilane or some other functional group that is capable of reacting with the silane.

In a preferred embodiment, the fluorinated compound is a fluoroalkylsilane (FAS), which are used to form self-assembled monolayers (SAMs). Examples of suitable fluoroalkylsilanes include, but are not limited to, (heptadecafluoro-1,1,2,2-tetrahydrodecyl)trichlorosilane (FDTS), (tridecafluoro-1,1,2,2-tetrahydrooctyl)trichlorosilane (FOTS), (heptadecafluoro-1,1,2,2-tetrahydrodecyl) triethoxylsilane, (tridecafluoro-1,1,2,2-tetrahydrooctyl)triethoxysilane, (heptadecafluoro-1,1,2,2-tetrahydrodecyl)trimethoxylsilane, (tridecafluoro-1,1,2,2-tetrahydrooctyl)-trimethoxysilane, perfluorooctyldimethylchlorosilanes, fluoropropylmethyldichlorosilanes, and perfluorodecyldimethylchlorosilanes. In a presently preferred embodiment, the fluoroalkylsilane is FDTS or FOTS. Other FAS compounds suitable for use in the present invention are known to those of skill in the art.

In other embodiments, the second coating can comprise a compound other than a fluoroalkylsilane. Examples of suitable compounds include, but are not limited to, undecenyltrichlorosilanes (UTS), vinyl-trichlorosilanes (VTS), decyltrichlorosilanes (DTS), octadecyltrichlorosilanes (OTS), dimethyldichlorosilanes (DDMS), dodecenyltricholrosilanes (DDTS), and aminopropylmethoxysilanes (APTMS).

The first and second coatings can be applied to the substrates by any method known in the art including for example screen printing, electrospray, ink jet, vapor or plasma deposition or spin coating. The deposition of such polymers is described in, for example, Characterization of Organic Thin Films; Ulman, A., Ed.; Manning: Greenwich, 1995 (ISBN 0-7506-9467-X) and Polymer Handbook, 3^{rd} edition; Brandrup, J. and Immergut, E. H., Eds.; John Wiley & Sons: New York, 1989 (ISBN 0-471-81244-7).

In a presently preferred embodiment, the first and second coatings are applied to the substrates using chemical vapor deposition (CVD) (or molecular vapor deposition (MVD)) techniques known to and used by those of skill in the art. Examples of preferred chemical vapor deposition techniques are disclosed in U.S. Patent Publication Nos. US 2005/0271893 (Kobrin et al., “Controlled Vapor Deposition Of Multilayered Coatings Adhered By An Oxide Layer,” Dec. 8, 2005) and US 2006/0088666 (Kobrin et al., “Controlled Vapor Deposition Of Biocompatible Coatings Over Surface-Treated Substrates,” Apr. 27, 2006), the teachings of both of which are incorporated herein by reference.

To create the features or openings in the second coating, a lithographic process can be used. This can be done by masking the area prior to deposition or by removing deposited material by etching or burning with an electron, a laser or an ion beam process, or employing a more sophisticated photolithographic process, such as treatment with ozone in the presence of UV radiation. In a preferred embodiment, the features or openings in the second coating (e.g., FDTS) are created by removal of the second coating by treatment with ozone in the presence of UV radiation. In this embodiment, the second coating is covered with a mask comprising a plurality of openings that expose a plurality of areas on the second coating; and the probe is exposed to ozone in the presence of UV radiation to remove the fluoroalkylsilane from the exposed areas. Once the features have been created, an adsorbent material is physisorbed or chemisorbed to the first coating at the plurality of openings.
C. Adsorbent Materials

Removal of the hydrophobic material from a plurality of locations on the probe exposures the first coating, e.g., silicon dioxide, underneath. The reactive moieties in first coating material, e.g., hydroxyl groups, can then be coupled with an anchor moiety to which the adsorbent material can be attached, preferably through chemisorption. For example, the anchor moiety is a molecule coupled to the first coating through a silane moiety which further comprises a polymerizable moiety, e.g., a vinyl group (for example an acrylate or a methacrylate), through which a polymeric adsorbent can be attached. In one embodiment, the anchor moiety is a vinyl alkyl silane, for example, 3-(tri-methoxy)silyl propyl methacrylate.

In certain embodiments, the adsorbent material can be coupled directly to the anchor moiety without the formation of a long polymer. However, in preferred embodiments, the adsorbent material comprises a hydrogel, that is, a cross-linked, water-swellable polymer. Numerous hydrogel can be used, but preferred hydrogels comprise acrylate, methacrylate or polysaccharide, e.g., dextran, polymers. Such hydrogels are described in detail in a variety of publications. These include, for example: U.S. Pat. No. 6,897,072 (Rich et al., “Probes for a Gas Phase Ion Spectrometer,” May 24, 2005); U.S. Patent Publication No. U.S. 2003 0032043 A1 (Pohl et al., “Latex Based Adsorbent Chip,” Jul. 16, 2002); PCT International Publication No. WO 03/040700 (Um et al., “Hydrophobic Surface Chip,” May 15, 2003); U.S. Patent Publication No. US 2003/0218130 A1 (Boschetti et al., “Biochips With Surfaces Coated With Polysaccharide-Based Hydrogels,” Apr. 14, 2003); U.S. Pat. No. 7,045,366, (Huang et al., “Photocrosslinked Hydrogel Surface Coatings,” May 16, 2006); and PCT International Publication No. WO 06/039077 (Huang et al., “Host-Guest Energy-Absorbing Complex,” Apr. 13, 2006).

Several ways of generating a hydrogel coupled to anchor moieties on the spot are contemplated. In a first embodiment, the hydrogel is created by polymerizing acrylate or methacrylate monomers, including cross-linking monomers on the spot. The vinyl groups on the anchor moieties will be involved in the polymerization reaction, resulting in a cross-linked hydrogel which is coupled through the product of the polymerization reaction to the anchor moiety and, thereby, to the surface. Typically, the polymerizable monomers are themselves derivatized with binding functionalities. Useful monomers include, for example, acrylic acid (cation exchange), N-(3-N,N-dimethylaminopropyl) methacrylamide (anion exchange), nonylphenoxypoly(ethylenoxy)ethyl methacrylate (hydrophobic), and O-methacryloyl-N,N-bis-carboxymethyl tyrosine (IMAC). To cross-link the gel, a cross-linking agent, such as N,N′-methylenebis(acrylamide) is provided. The amount of cross-linker added to the polymerization solution can be around 5% to 10% by weight.

In a second embodiment, the hydrogel is created from a polysaccharide, e.g., dextran (e.g., molecular mass between 10 and 2000 kDa), that itself is derivatized with moieties including vinyl groups, for example, glycidyl methacrylate. This modified dextran is then polymerized on the surface through the vinyl groups to produce a hydrogel. The polysaccharide is also derivatized, before or after cross-linking, with binding moieties. It can be derivatized also after coating on the probe surface.

In a third embodiment, a polysaccharide, such as dextran, is modified to include photoreactive moieties such as benzophenone groups. Upon exposure to light, the groups will react with moieties comprising abstractable hydrogen atoms to form a bond. In this way, the polysaccharide molecules couple to each other and to available groups on the anchor moiety. Examples of such hydrogels are disclosed in U.S. Patent Publication No. 2005/0059086 (Huang, et al, “Photocrosslinked Hydrogel Blend Surface Coatings,” Mar. 17, 2005), the teachings of which are incorporated herein by reference.

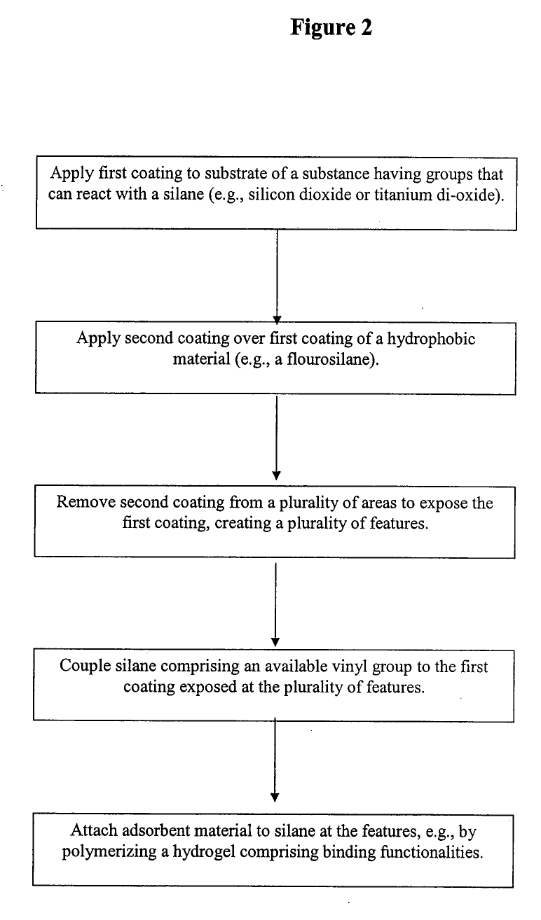

Typically, the probes of the present invention are generated in two discrete stages as set forth in the Example Section and in FIG. 2. The first stage includes plasma cleaning, silicon dioxide (SiO2) deposition, and fluoroalkylsilane (e.g., FDTS) deposition. The second state includes UV/ozone cleaning/patterning and methacrylate deposition. The thickness of the silicon dioxide coating can be measured by FTIR, whereas FDTS and methacrylate deposition can be measured by contact angle. Again, the contact angle of the methacrylate-derivatized feature should be about 20° lower (preferably 30° lower or more) than the contact angle of the FDTS or other fluoroalkylsilane (FAS).

Again, the surface tension of the second coating is lower than the surface tension of the features on the probe surface so that liquid applied to the exposed areas tends to be sequestered in the plurality of features or openings. More particularly, the surface tension of the second (FDTS) coating is lower than the first (SiO2) coating, and the contact angle is inversely-related. As such, the second coating has a higher contact angle than the first coating. Again, in preferred embodiments, the second coating should have a contact angle 20° higher, more preferably 30° higher and, even more preferably 40° higher than the first coating.

### III. Methods of Detection

The probes of this invention are useful in the detection of analytes placed on the features of the probe. In these methods, the probes are used in connection with a gas phase ion spectrometer. This includes, e.g., mass spectrometers, ion mobility spectrometers or total ion current measuring devices.

In one embodiment, a mass spectrometer is used with the probe of the present invention. A sample placed on the feature of the probe of the present invention is introduced into an inlet system of the mass spectrometer. The sample is then ionized by an ionization source. Typical ionization sources include, e.g., laser, fast atom bombardment, or plasma. The generated ions are collected by an ion optic assembly, and then a mass analyzer disperses and analyzes the passing ions. The ions exiting the mass analyzer are detected by a detector. The detector then translates information of the detected ions into mass-to-charge ratios. Detection of an analyte will typically involve detection of signal intensity. This, in turn, reflects the quantity of analyte bound to the probe. For additional information regarding mass spectrometers, see, e.g., Principles of Instrumental Analysis, 3^{rd} ed., Skoog, Saunders College Publishing, Philadelphia, 1985; and Kirk-Othmer Encyclopedia of Chemical Technology, 4^{th} ed. Vol. 15 (John Wiley & Sons, New York 1995), pp. 1071-1094.

In a preferred embodiment, a laser desorption time-of-flight mass spectrometer is used with the probe of the present invention. In laser desorption mass spectrometry, a sample on the probe is introduced into an inlet system. The sample is desorbed and ionized into the gas phase by laser from the ionization source. The ions generated are collected by an ion optic assembly, and then in a time-of-flight mass analyzer, ions are accelerated through a short high voltage field and let drift into a high vacuum chamber. At the far end of the high vacuum chamber, the accelerated ions strike a sensitive detector surface at a different time. Since the time-of-flight is a function of the mass of the ions, the elapsed time between ionization and impact can be used to identify the presence or absence of molecules of specific mass. As any person skilled in the art understands, any of these components of the laser desorption time-of-flight mass spectrometer can be combined with other components described herein in the assembly of mass spectrometer that employs various means of desorption, acceleration, detection, measurement of time, etc.

Furthermore, an ion mobility spectrometer can be used to analyze samples. The principle of ion mobility spectrometry is based on different mobility of ions. Specifically, ions of a sample produced by ionization move at different rates, due to their difference in, e.g., mass, charge, or shape, through a tube under the influence of an electric field. The ions (typically in the form of a current) are registered at the detector which can then be used to identify the sample. One advantage of ion mobility spectrometry is that it can operate at atmospheric pressure.

Still further, a total ion current measuring device can be used to analyze samples. This device can be used when the probe has a surface chemistry that allows only a single type of analytes to be bound. When a single type of analytes is bound on the probe, the total current generated from the ionized analyte reflects the nature of the analyte. The total ion current from the analyte can then be compared to stored total ion current of known compounds. Therefore, the identity of the analyte bound on the probe can be determined.

In addition to the foregoing, it will be readily apparent to those of skill in the art that the probes of the present invention can be used in combination with other detections methods. Detection paradigms include optical methods, electrochemical methods (voltametry and amperometry techniques), atomic force microscopy, and radio frequency methods, e.g., multipolar resonance spectroscopy. Illustrative of optical methods, in addition to microscopy, both confocal and non-confocal, are detection of fluorescence, luminescence, chemiluminescence, absorbance, reflectance, transmittance, and birefringence or refractive index (e.g., surface plasmon resonance, ellipsometry, a resonant mirror method, a grating coupler waveguide method or interferometry). The probes of the present invention can advantageously be used in any device or detector that requires the segregation of a sample to a defined spot.

### IV. EXAMPLES

### Example 1

A probe of this invention is constructed as follows (see, FIG. 1). An aluminum strip 101 having dimensions 80 mm×9 mm×25 mm was prepared. The aluminum strip includes a lip 102 that engages a complementary receiving structure in the probe. Silicon dioxide (SiO₂) was deposited by molecular vapor deposition (MVP) on the long surface of a strip to create a first coating 105. FDTS was then deposited by MVD on the long surface of the strip to create a second coating 106. The first coating and the second coating covered virtually the entire surface of the strip. Eight (8) openings in the shape of circles (2.4 mm diameter) defining features 103 were created in the strip by exposing the strip to ozone in the presence of UV radiation. Methyacrylsilane 107 was then deposited by MVD in the features 103. Once the methylacrylsilane was deposited in the features 104, the probe was ready for derivatization with the adsorbent 108 of interest.

### Example 2

This example illustrate the preparation of the use of an MVD procedure for glass-coated chips with a hydrophobic barrier and having eights features or spots.

Lot size: 160 arrays-14 universal racks.

The racks containing 160 grit blasted bare substrates and 1 polished witness substrate are placed in the MVD chamber in the following arrangement:

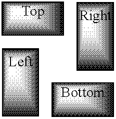

Witness substrate will be placed in exactly the same position in the chamber—in the bottom group on the bottom rack.

1. Plasma cleaning:
Flow set: 450
Pwr set: 200
Pwr ref: 5
Chamber pressure: 0.45 torr
Time: 5 min.

2. Glass coating:

The glass coating step immediately follows the plasma cleaning step (ideally, without venting or opening the chamber).
2×18 SiCl4/8×18 H2O
Time: 15 min
   The glass thickness should be higher than 100 A, but this may be varied. When the thickness drops under 100 A, a deep cleaning of the chamber is typically necessary. At this point, it may be a break in the process, but preferably the FDTS is deposited without venting the chamber.

3. FDTS deposition:
4×0.5 FDTS/1×18 H2O
15 min
   After FDTS deposition, the MVD chamber is typically plasma cleaned for about 15 min. At this point, there can be a break in the process and the glass and FDTS coated chips can be stored without any particular precautions.

4. UV/Ozone cleaning/patterning of arrays after FDTS deposition:
Time: 30 min

In one embodiment, the UV/ozone cleaning/patterning step takes about 40 min. If the deposition is performed in a perfectly clean chamber, it is likely that this step can be reduced to 30 min. or less.

This step is followed by in-process inspection of the chip. The CA on the spot or features should be less than 5° on the spot. UV/ozone times may vary. If the CA is not low enough, then UV/ozone treatment should continue until the appropriate CA is obtained. FTIR intensity signal at 1225 cm⁻¹ will indicate the thickness of the glass coating. The height of the signal is measured after baseline correction in a display window from 1600 to 900 cm¹. The height of the signal can be translated in glass thickness using a correlation curve.

5. Methacrylsilane deposition:

The temperature for the methacrylsilane line is turned on about 10 min. before starting. When the temperature riches about 60° C., the line needs to be purged a few times in manual mode until the pressure is not higher than 0.6 torr. If, at first, the pressure is not higher than 0.6 torr, increase the set temperature about 2° C. Frequently, this is an indication that the level of methacrylsilane is low and another cylinder has to be prepared.
4×0.5 meths/1×18 H2O
Time: 15 min

The temperature for the methacrylsilane line is turned off immediately after the chamber is filled with methacrylsilane.

This step is followed by in-process inspection of the chip. Ideally, the CA on the spot or feature should be lower than about 95°, whereas the CA outside the spot (on the smooth area) for FDTS should be about 115-120°. If the CA is higher than 95° on the spot, the lot can be further treated with UV/ozone until a lower CA is obtained. Again, ideally there should be about a 20° difference between the CA of the spot or feature and the CA of the second coating (e.g., the FDTS coating).

At this point, the chips can be stored in a clean and dry environment.

The present invention provides novel probes for gas phase ion detectors having coatings on their surfaces that sequester sample. While specific examples have been provided, the above description is illustrative and not restrictive. Many variations of the invention will become apparent to those skilled in the art upon review of this specification. The scope of the invention should, therefore, be determined not with reference to the above description, but instead should be determined with reference to the appended claims along with their full scope of equivalents.

All publications and patent documents cited in this application are incorporated by reference in their entirety for all purposes to the same extent as if each individual publication or patent document were so individually denoted. By their citation of various references in this document Applicants do not admit that any particular reference is “prior art” to their invention.

What is claimed is:

1. A probe comprising:
a. a solid substrate;
b. a first coating of silicon dioxide or titanium dioxide on a surface of the substrate;
c. a second coating of a fluoroalkylsilane chemically coupled to the first coating, wherein the second coating comprises a plurality of openings at which the polyfluoroalkylsilane is not present; and
d. adsorbent material physisorbed and/or chemisorbed to the first coating at the plurality of openings.

2. The probe of claim 1 wherein the probe is in the shape of a flat strip or plate.

3. The probe of claim 1 further comprising means for engaging a probe interface of a laser desorption mass spectrometer.

4. The probe of claim 1 wherein the solid substrate comprises a conductive material.

5. The probe of claim 1 wherein the solid substrate comprises a metal.

6. The probe of claim 3 wherein the solid substrate comprises aluminum, iron or gold.

7. The probe of claim 1 wherein the solid substrate comprises a conductive polymer or a polymer doped with a material to render it conductive.

8. The probe of claim 1 wherein the fluoroalkylsilane comprises (heptadecafluoro-1,1,2,2-tetra-hydrodecyl)trichlorosilane or (tridecafluoro-1,1,2,2-tetrahydrooctyl)trichlorosilane.

9. The probe of claim 1 wherein the fluoroalkylsilane comprises (heptadecafluoro-1,1,2,2-tetra-hydrodecyl)trichlorosilane.
